(19) United States
(12) Patent Application Publication
(10) Pub. No.: US 2010/0272313 A1
(43) Pub. Date: Oct. 28, 2010

(54) FORGERY PREVENTION MEDIUM

(75) Inventors: Tsuyoshi YAMAUCHI, Shinjuku-ku (JP); Mitsuru KITAMURA, Shinjuku-ku (JP); Makio KURASHIGE, Shinjuku-ku (JP); Tomoki YASUDA, Shinjuku-ku (JP)

Correspondence Address: SUGHRUE MION, PLLC, 2100 PENNSYLVANIA AVENUE, N.W., SUITE 800, WASHINGTON, DC, 20037, US

(73) Assignee: DAI NIPPON PRINTING CO., LTD., Tokyo (JP)

(21) Appl. No.: 12/767,942

(22) Filed: Apr. 27, 2010

(30) Foreign Application Priority Data
Apr. 27, 2009 (JP) 2009-107619

(51) Int. Cl. G06K 9/00

(52) U.S. Cl. 382/100

(57) ABSTRACT

A forgery prevention medium includes a volume hologram layer on which an interference pattern is recorded after being exposed to at least an emitted laser beam; a digital watermarking information layer on which digital watermarking information is recorded; and a substrate film, and the information recorded on the digital watermarking information layer is interpreted by emitting a light beam that is different in one or more of the characteristics, incidence direction, incidence angle and incidence wavelength, from a hologram reproduction illumination beam used to reproduce an image recorded on the volume hologram layer.

### CROSS REFERENCE TO RELATED APPLICATIONS

This application claims benefit of Japanese Application No. 2009-107619 filed in Japan on Apr. 27, 2009, the contents of which are incorporated by this reference.

### BACKGROUND OF THE INVENTION

1. Technical Field

The present invention relates to a forgery prevention medium and particularly to a forgery prevention medium that makes use of a hologram applied for determining authenticity to prevent forgery.

2. Background Art

Various means of preventing forgery have been used for goods that need forgery prevention as well as authentication, such as cards including cash cards, credit cards and check cards, cash vouchers, identification papers, and important documents. For example, a rainbow hologram consisting of a relief hologram having a metallic reflective layer is provided as a structure for authentication on the surface of the credit card to allow a visual determination of the card's authenticity. A recording device for such a hologram is disclosed in JP-B-60-30948.

There is a technique for recording information on such a hologram, managing data, and verification. After the recording of hologram, printing is done on the surface of the hologram to record information on the hologram. As shown in FIG. 22A to 22C, recorded as information are barcodes (FIG. 22A), two-dimensional barcodes (FIG. 22B), serial numbers (FIG. 22C), and the like. Although visual inspection may not lead to an understanding of the recorded information, it can be confirmed that some sort of information has been recorded. Since it is possible to visually confirm the presence of the information, the hologram can be forged by printing the same information even if the content of the information cannot be understood.

Therefore, a method of recording information with UV or IR emission ink would be used to make it impossible to visually confirm the recorded information.

Incidentally, techniques for printing information on holograms are disclosed in JP-A-62-133476, JP-A-2004-268258, and Jpn. PCT National Publication No. 2005-006166.

However, according to the conventional methods, when individual information is recorded, the recorded information could disturb and hurt the design of the hologram. A specific area on which the individual information is printed needs to be provided to keep the individual information from disturbing the design. However, the problem is that providing the specific area leads to an increase in the size of the hologram. The method of recording information with UV or IR emission ink can prevent the recorded information from disturbing the design of the hologram. However, there is a problem of increasing costs due to the necessity of selecting recording methods or materials to make it impossible to visually confirm the recorded information. Moreover, productivity is not good because the information needs to be positioned appropriately relative to the design.

### SUMMARY OF THE INVENTION

A forgery prevention medium includes a volume hologram layer on which an interference pattern is recorded after being exposed to at least an emitted laser beam; a digital watermarking information layer on which digital watermarking information is recorded; and a substrate film, and the information recorded on the digital watermarking information layer is interpreted by emitting a light beam that is different in one or more of the characteristics, incidence direction, incidence angle and incidence wavelength, from a hologram reproduction illumination beam used to reproduce an image recorded on the volume hologram layer.

The digital watermarking information layer consists of a resin layer including a pigment or a dye.

The digital watermarking information layer is made of liquid crystal.

The digital watermarking information layer is formed after being changed in quality or engraved.

The digital watermarking information layer is formed by printing.

The digital watermarking information layer is formed by thermal transfer.

The digital watermarking information layer is formed by a laser.

The digital watermarking information layer is formed on the surface of the forgery prevention medium.

A protective layer that protects the digital watermarking information layer is formed on the surface of the forgery prevention medium on which the digital watermarking information layer is formed.

The digital watermarking information layer is formed inside the forgery prevention medium.

An adhesive layer that is to be detached from the substrate film and bonded to an adherend is provided.

A heat seal layer is provided to thermally transfer the volume hologram layer to an adherend.

The digital watermarking information having a high level of secrecy is used for the hologram having a high level of reliability in terms of security. Therefore, the information is difficult to interpret by eye under normal conditions. Thus, it is possible to improve the effect of forgery prevention. Moreover, since the digital watermarking information having redundancies is used, it is possible to efficiently produce the forgery prevention medium without complicated processes such as alignment.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is a diagram illustrating the observation of a reproduction image of a volume hologram layer of a forgery prevention medium.

FIG. 2 is a diagram illustrating a case in which a reproduction image of a volume hologram layer of a forgery prevention medium is not observed.

FIG. 3 is a cross-sectional view of a forgery prevention medium before being given digital watermarking information according to a first embodiment of the present invention.

FIG. 4 is a cross-sectional view of the forgery prevention medium after being given digital watermarking information according to the first embodiment of the present invention.

FIG. 5 is a cross-sectional view of a forgery prevention medium before being given digital watermarking information according to a second embodiment of the present invention.

FIG. 6 is a cross-sectional view of the forgery prevention medium after being given digital watermarking information according to the second embodiment of the present invention.

FIG. 7 is a cross-sectional view of a substrate film on which a resin layer that is given digital watermarking information is formed according to a third embodiment of the present invention.

FIG. 8 is a cross-sectional view of a forgery prevention medium after label processing according to the third embodiment of the present invention.

FIG. 9 is a cross-sectional view of a forgery prevention medium after label processing according to a fourth embodiment of the present invention.

FIG. 10 is a cross-sectional view of a forgery prevention medium after label processing according to a fifth embodiment of the present invention.

FIG. 11 is a cross-sectional view of a forgery prevention medium before being given digital watermarking information according to a sixth embodiment of the present invention.

FIG. 12 is a cross-sectional view of the forgery prevention medium after being given digital watermarking information according to the sixth embodiment of the present invention.

FIG. 13 is a cross-sectional view of a forgery prevention medium before being given digital watermarking information according to a seventh embodiment of the present invention.

FIG. 14 is a cross-sectional view of the forgery prevention medium after being given digital watermarking information according to the seventh embodiment of the present invention.

FIG. 15 is a cross-sectional view of a forgery prevention medium before being given digital watermarking information according to an eighth embodiment of the present invention.

FIG. 16 is a cross-sectional view of the forgery prevention medium after being given digital watermarking information according to the eighth embodiment of the present invention.

FIG. 17 is a cross-sectional view of a forgery prevention medium before being given digital watermarking information according to a ninth embodiment of the present invention.

FIG. 18 is a cross-sectional view of the forgery prevention medium after being given digital watermarking information according to the ninth embodiment of the present invention.

FIG. 19 is a diagram illustrating an embodiment of the present invention by which the engraving of the surface side of the layer configuration of FIG. 3 is performed.

FIG. 20 is a diagram illustrating an embodiment of the present invention by which the engraving of the surface side of the layer configuration of FIG. 11 is performed.

FIG. 21 is a diagram illustrating digital watermarking information on a multifaceted hologram.

FIG. 22 is a diagram illustrating information recorded on conventional holograms.

FIG. 23 is a diagram illustrating the misaligned digital watermarking information on the multifaceted hologram.

### DESCRIPTION OF EXEMPLARY EMBODIMENTS

A forgery prevention medium of the present invention will be described hereinafter with reference to the accompanying drawings. The forgery prevention medium is equipped with a volume hologram layer 2 where interference patterns are recorded by the exposure to an emitted laser beam; and information layers 21 and 23 that are digital watermarking information layers where digital watermarking information is recorded. Information recorded on the information layers 21 and 23 is interpreted by emitting a light beam that is different in one or more of the following characteristics from a hologram reproduction illumination beam used to reproduce an image recorded on the volume hologram layer 2: incidence direction, incidence angle, and incidence wavelength.

That is, what is recorded is the digital watermarking information that is difficult to interpret by eye but is possible for a dedicated reader to interpret. The digital watermarking information refers to information that is different from the design or pattern of hologram that is embedded in the hologram so as not to harm the characteristics of the hologram and is discernible to the eye. It is desirable that the digital watermarking information be the repeating-pattern information made by a predetermined algorithm. Incidentally, a method of inserting and reading digital watermarks is disclosed in JP-A-10-145757.

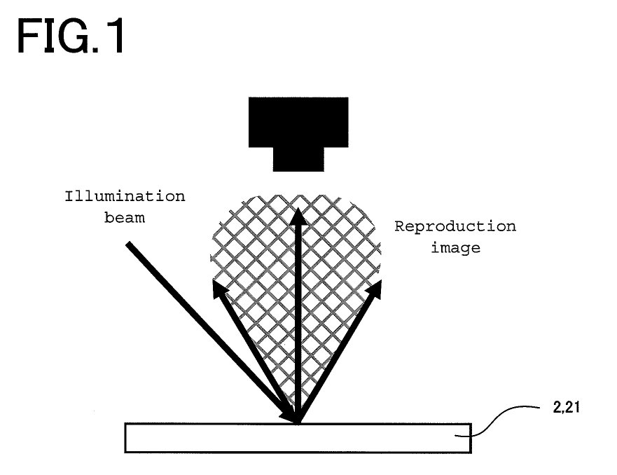

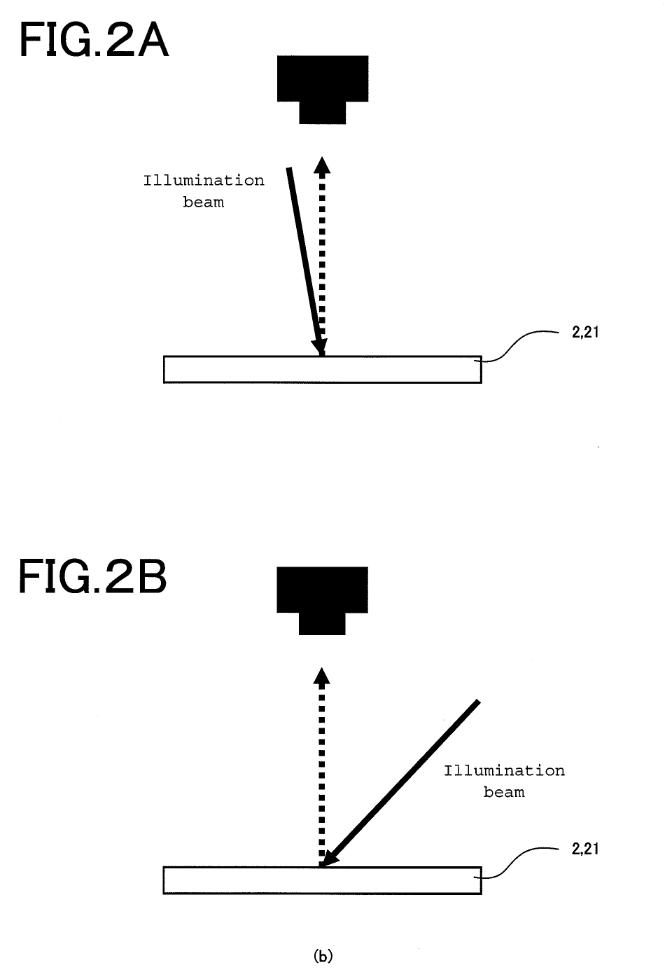

In the forgery prevention medium having the information layer 21 and the volume hologram layer 2, when a reproduction image of the volume hologram layer 2 is observed, an illumination beam entering at an angle designed to reproduce the image allows the observation of the reproduction image of the volume hologram layer 2 as shown in FIG. 1. As shown in FIG. 2, when the illumination beam enters at a different angle from the angle designed to reproduce the image, the reproduction image of the volume hologram layer 2 cannot be observed. In the case of Lippmann hologram, since the angular selectivity is high, the reproduction image of the volume hologram layer 2 is not reproduced when the incidence angle of the illumination beam is different from the designed one, making it easy to read only the information of the information layer 21. Moreover, since the wavelength selectivity is also high, the image is not reproduced if the wavelength is different even when the illumination beam enters at the angle designed to reproduce the reproduction image of the volume hologram layer 2, making it easy to read only the information of the information layer 21.

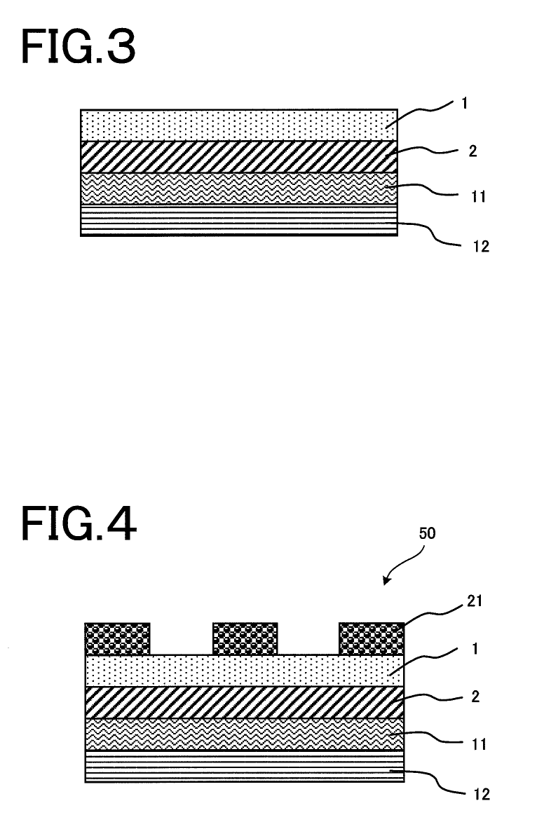

FIGS. 3 and 4 are diagrams illustrating a forgery prevention medium according to a first embodiment of the present invention. FIG. 3 is a cross-sectional view of the forgery prevention medium of the first embodiment before being given digital watermarking information. FIG. 4 is a cross-sectional view of the forgery prevention medium of the first embodiment after being given digital watermarking information.

As shown in FIG. 3, according to the first embodiment, first off the volume hologram layer 2 is formed on a substrate film 1 that is a hologram substrate.

The substrate film 1 is not limited to a specific material as long as the substrate film 1 has a certain level of mechanical strength. For example, PET films or the like can be used. The thickness of the hologram substrate 1 usually falls in a range of 5 μm to 200 μm and preferably in a range of 10 μm to 50 μm.

To form the volume hologram layer 2, coating is applied to the surface of the substrate film 1 by a typical coating means such as spin coater and gravure coater and, when necessary, is dried. Conventional, publicly-known materials for volume holograms can be used as materials for the hologram. More specifically, the materials for example include silver halide photosensitive materials, dichromated gelatin, photo-cross-linked polymer, and photopolymer. In particular, compared with other materials, photopolymer enables the volume hologram to be produced only with dry process and is good in mass production. The photopolymer used for hologram materials includes at least one kind of photopolymerizable compound and a photoinitiator.

In the volume hologram, interference patterns are recorded and formed as a result of modulation of refractive indexes and transmissivity. When the volume hologram layer 2 is exposed to the emitted laser beam, the polymerization of the photopolymerizable compound occurs and interference patterns are recorded. The laser beams used for holography exposure include argon ion laser beams (457.9 nm, 476.5 nm, 488.0 nm, and 514.5 nm), krypton ion laser beams (647.1 nm), helium-neon laser beams (632.8 nm), and YAG laser beams (532 nm).

Conventional, publicly-known methods can be used to record the interference patterns of the above image. For example, with an original plate firmly put on the volume hologram layer 2, interference exposure is conducted by using a visible light beam or an ionizing radiation, such as ultraviolet rays and electron beams, on the substrate film 1 to record the interference patterns of the image.

Moreover, in order to promote modulation of refractive indexes and complete the polymerization reaction of the photopolymerizable compound and the like, the exposure of the entire surface to ultraviolet rays, application of heat or other processes can be performed when needed after the interference exposure.

Then, label processing is performed on the forgery prevention medium to make the forgery prevention medium easy to use.

A label substrate 12 is detached when the forgery prevention medium 50 that is given information is attached to an adherend. The label substrate 12 is not limited to a specific material as long as the ease with which the label substrate 12 can be detached from an adhesive layer 11 is at a moderate level and the label substrate 12 has a certain level of mechanical strength. The materials for example include transparent resin films such as PET films and polyvinyl chloride (PVC) films.

The thickness of the film used for the label substrate 12 is selected appropriately according to usage and type of the label and the like. The thickness of the film usually falls in a range of 2 μm to 200 μm and preferably in a range of 10 μm to 100 μm.

When being processed into a label, the adhesive layer 11 is to cause the forgery prevention medium 50 to adhere to the adherend. The adhesive layer 11 is obtained by using, for example, acrylate resin, acrylic ester resin, copolymer of the acrylate resin or acrylic ester resin, styrene-butadiene copolymer, natural rubber, casein, gelatin, rosin ester, terpene resin, phenolic resin, styrenic resin, chroman-indene resin, polyvinyl ether, silicon resin, and the like; also used are α-cyanoacrylate-based, silicon-based, maleimide-based, styrol-based, polyolefin-based, resorcinol-based, and polyvinyl ether-based adhesives. It is preferable that the thickness of the adhesive layer 11 is within a range of 4 μm to 30 μm.

As shown in FIG. 4, the information layer 21 made of digital watermarking information is then formed. According to the present embodiment's method of producing the forgery prevention medium that is given digital watermarking information, the information layer 21 is formed on the hologram substrate 1.

According to the method of forming the information layer 21, inkjet printing, liquid transfer printing and the like can be used. Pigment-based inks are used for inkjet printing and liquid transfer printing.

Incidentally, the formation of the information layer 21 may come before the label processing. It is preferable that the information layer 21 have redundancies.

The following describes a second embodiment of the present invention.

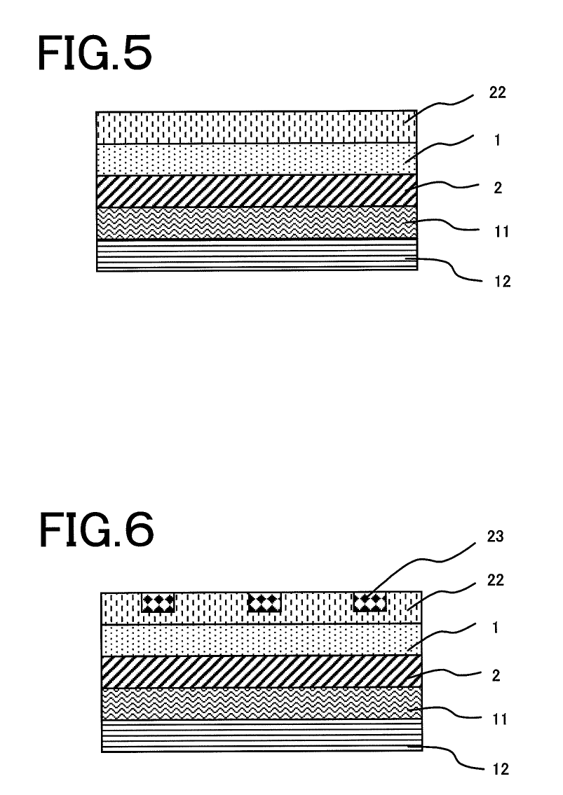

FIGS. 5 and 6 are diagrams illustrating a forgery prevention medium according to the second embodiment of the present invention. FIG. 5 is a cross-sectional view of the forgery prevention medium of the second embodiment before being given digital watermarking information. FIG. 6 is a cross-sectional view of the forgery prevention medium of the second embodiment after being given digital watermarking information.

As shown in FIG. 5, according to the second embodiment, first off the volume hologram layer 2 is formed on the substrate film 1 that is a hologram substrate in a similar way to the first embodiment. After that, label processing is performed to make the forgery prevention medium easy to use. The label processing is the same as that of the first embodiment.

Subsequently, a laser beam is emitted and the volume hologram layer 2 is exposed to the laser beam. Then, a resin layer 22 is formed as an image receiving layer on the opposite side of the substrate film 1 from the volume hologram layer 2.

As shown in FIG. 6, the information layer 23 made of digital watermarking information is then formed. According to the present embodiment's method of producing the forgery prevention medium 50 that is given digital watermarking information, the information layer 23 is formed on the resin layer 22.

According to the method of forming the information layer 23, inkjet printing, sublimation transfer printing and the like can be used. Dye-based inks are used for inkjet printing, sublimation transfer printing and the like.

Incidentally, the formation of the resin layer 22 and the information layer 23 may come before the label processing. It is preferable that the information layer 21 have redundancies.

The following describes a third embodiment of the present invention. The third embodiment is an alternative to the second embodiment.

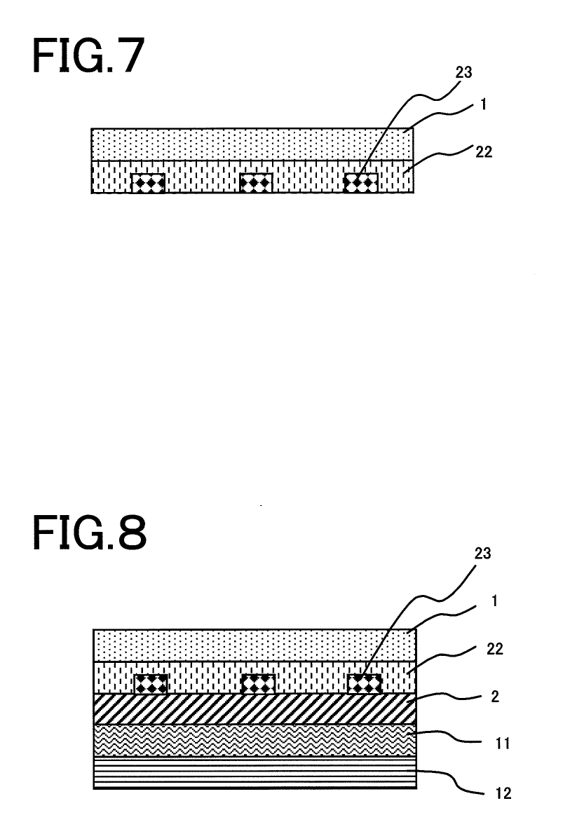

FIGS. 7 and 8 are diagrams illustrating a forgery prevention medium according to the third embodiment of the present invention. FIG. 7 is a cross-sectional view of a substrate film on which a resin layer that is given digital watermarking information is formed according to the third embodiment. FIG. 8 is a cross-sectional view of the forgery prevention medium of the third embodiment.

According to the third embodiment, before the volume hologram layer 2 is formed on the substrate film 1 that is a hologram substrate, the resin layer 22 is formed as an image receiving layer on the substrate film 1 as shown in FIG. 7. Then, the information layer 23 is formed on the resin layer 22. According to the method of forming the information layer 23, like the second embodiment, inkjet printing, sublimation transfer printing and the like can be used with dye-based inks.

As shown in FIG. 8, the volume hologram layer 2 is formed on the opposite side of the resin layer 22 from the substrate film 1. A laser beam is emitted and the volume hologram layer 2 is exposed to the laser beam.

Then, the label processing is performed of the forgery prevention medium 50 on which the information layer 23 is formed, making the forgery prevention medium 50 easy to use. The label processing is the same as that of the first embodiment.

When the forgery prevention medium 50 is formed as described above, light is blocked by the information layer 23 at the time of laser exposure, and the information layer 23 is recorded on the volume hologram layer 2 as a shadow. It is preferable that the information layer 23 have redundancies.

Since the information layer 23 does not border on the surface, falsification can be prevented. Moreover, the information layer 23 is rarely affected by scratches and stains.

The following describes another production method of the third embodiment.

According to another production method of the third embodiment, the substrate film 1 to which a detachment process is applied is used, and the substrate film 1 is detached after laser exposure. Subsequently, the information layer 23 is formed on the resin layer 22. The volume hologram layer 2 is stacked on the information layer 23′ s side of the resin layer 22. After that, the substrate film 1 is bonded to the resin layer 23 for production.

Materials used for the detachment process may include, for example, one type of or two or more types of the following substances combined: acrylic resin, methacrylic resin, polyvinylchloride resin, silicon resin, various types of surface active agents, metal oxides, and the like.

The following describes a forgery prevention medium 50 according to a fourth embodiment of the present invention.

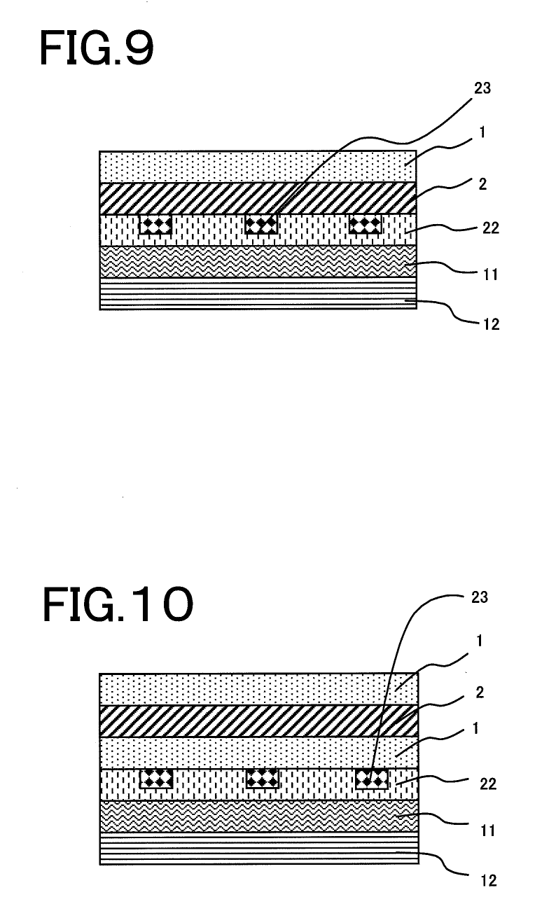

FIG. 9 is a cross-sectional view of the forgery prevention medium of the fourth embodiment after the label processing is performed.

According to the fourth embodiment, first off the volume hologram layer 2 is formed on the substrate film 1 that is the hologram substrate 1. A laser beam is emitted and the volume hologram layer 2 is exposed to the laser beam.

The information layer 23 is formed on the resin layer 22 that serves as an image receiving layer. According to the method of forming the information layer 23, like the second embodiment, inkjet printing, sublimation transfer printing, and the like can be used with dye-based inks.

Then, the substrate film 1 on which the volume hologram layer 2 is formed is stacked on the resin layer 22 so that the volume hologram layer 2 and the information layer 23 sit side by side.

Subsequently, the label processing is performed on the forgery prevention medium 50 on which the information layer 23 is formed, making the forgery prevention medium 50 easy to use. The label processing is the same as that of the first embodiment. It is preferable that the information layer 23 have redundancies.

Since the information layer 23 does not border on the surface, falsification can be prevented. Moreover, the information layer 23 is rarely affected by scratches and stains.

Incidentally, another method of forming the information layer 23 is to form a hologram layer on the substrate film 1, stack the resin layer 22 on which the information layer 23 is formed, and conduct laser exposure. When such a method is applied, the information of the information layer 23 can be recorded as holograms if an ink or the like that reflects or absorbs a laser beam is used for the information layer 23.

Moreover, after the label processing is performed on the resin layer 22 and the information layer 23, the substrate film 1 on which the volume hologram layer 2 is formed may be stacked.

FIG. 10 is a cross-sectional view of a forgery prevention medium of a fifth embodiment of the present invention after the label processing is performed. The fifth embodiment is an alternative to the fourth embodiment; after the substrate film 1 is stacked on the resin layer 22, the substrate film 1 on which the volume hologram layer 2 is formed is further stacked to form the forgery prevention medium 50.

Subsequently, the label processing is performed on the forgery prevention medium 50 to make the forgery prevention medium 50 easy to use. The label processing is the same as that of the first embodiment.

Incidentally, after the label processing is performed on the resin layer 22 and the information layer 23, the substrate film 1 on which the volume hologram layer 2 is formed may be stacked. It is preferable that the information layer 23 have redundancies.

Since the information layer 23 does not border on the surface, falsification can be prevented. Moreover, the information layer 23 is rarely affected by scratches and stains.

Described below is a forgery prevention medium 50 that employs a heat seal layer 16 when the volume hologram layer 2 that is given the information layer 21 made of digital watermarking information is processed into transfer foil.

The heat seal layer 16 is a layer used to bond the volume hologram layer that is given digital watermarking information and an adherend together through heating and the like after the volume hologram layer 2 is firmly put on the adherend when the volume hologram layer 2 that is given digital watermarking information is thermally transferred to the adherend.

For such a heat-sensitive adhesive layer, for example, thermoplastic resin such as ethylene vinyl acetate copolymer (EVA), polyamide resin, polyester resin and polyethylene resin may be used. Out of the above resins, a layer that allows heat sealing at 180 degrees Celsius or below is preferable. It is further preferable that the one whose acetic acid content of the ethylene vinyl acetate copolymer (EVA) is greater than or equal to 25 percent be used. Moreover, for the above resin, the heat-sensitive adhesive layer may be colored when necessary.

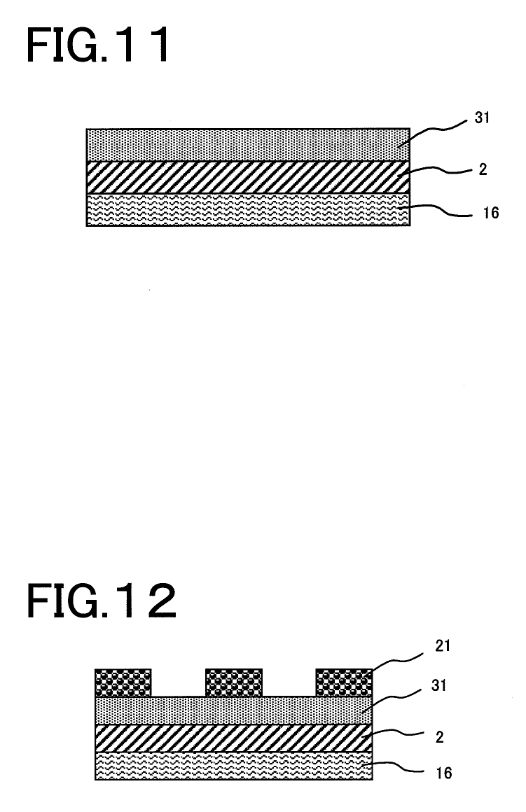

FIGS. 11 and 12 are diagrams illustrating a forgery prevention medium according to a sixth embodiment of the present invention. FIG. 11 is a cross-sectional view of the forgery prevention medium of the sixth embodiment before being given digital watermarking information. FIG. 12 is a cross-sectional view of the forgery prevention medium of the sixth embodiment after being given digital watermarking information.

As shown in FIG. 11, according to the sixth embodiment, first off the volume hologram layer 2 is formed on a protective layer 31.

Subsequently, the heat seal layer 16 is formed on the volume hologram layer 2 that is protected by the protective layer 31.

As shown in FIG. 12, a laser beam is then emitted and the volume hologram layer 2 is exposed to the laser beam. After that, the information layer 21 is formed. According to the present embodiment's method of producing the forgery prevention medium that is given digital watermarking information, the information layer 21 is formed on the protective layer 31.

According to the method of forming the information layer 21, inkjet printing, liquid transfer printing and the like can be used. Pigment-based inks are used for inkjet printing and liquid transfer printing. It is preferable that the information layer 21 have redundancies.

The heat seal layer 16 may be formed after the volume hologram layer 2 is protected by the protective layer 31 and the information layer 21 is formed.

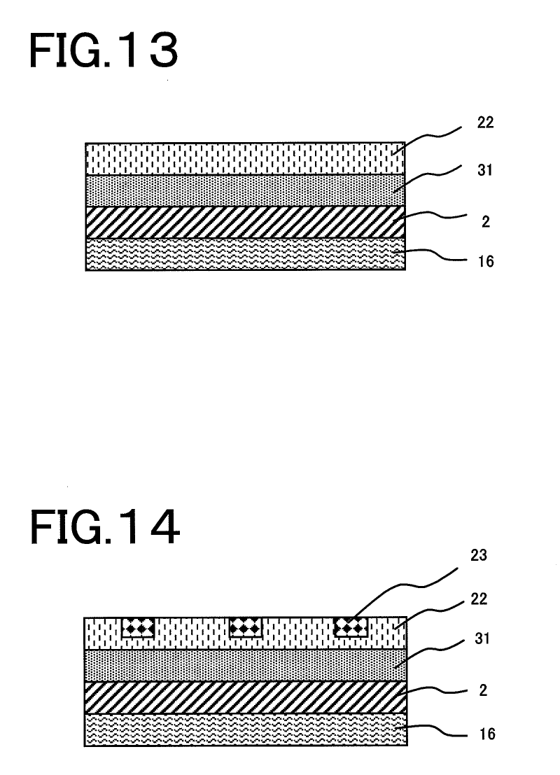

FIGS. 13 and 14 are diagrams illustrating a forgery prevention medium according to a seventh embodiment of the present invention. FIG. 13 is a cross-sectional view of the forgery prevention medium of the seventh embodiment before being given digital watermarking information. FIG. 14 is a cross-sectional view of the forgery prevention medium of the seventh embodiment after being given digital watermarking information.

As shown in FIG. 13, according to the seventh embodiment, first off the volume hologram layer 2 is formed on the protective layer 31.

Subsequently, the heat seal layer 16 is formed on the volume hologram layer 2 that is protected by the protective layer 31. Then, a laser beam is emitted and the volume hologram layer 2 is exposed to the laser beam. After that, the resin layer 22 is formed. According to the present embodiment's method of producing the forgery prevention medium that is given digital watermarking information, the resin layer 22 is formed on the protective layer 31.

Subsequently, as shown in FIG. 14, the information layer 23 is formed on the resin layer 22. It is preferable that the information layer 23 have redundancies.

According to the method of forming the information layer 23, inkjet printing, sublimation transfer printing and the like can be used. Dye-based inks are used for inkjet printing, sublimation transfer printing and the like.

Incidentally, another method of forming the information layer 23 is to stack the hologram layer 2 on the protective layer 31, stack the resin layer 22 on which the information layer 23 is formed, and conduct laser exposure. When such a method is applied, the information of the information layer 23 can be recorded as holograms if an ink or the like that reflects or absorbs a laser beam is used for the information layer 23.

Moreover, the heat seal layer 16 may be formed after the volume hologram layer 2 is protected by the protective layer 31 and the information layer 23 is formed.

The following describes an embodiment of the present invention by which digital watermarking information is recorded by laser marking.

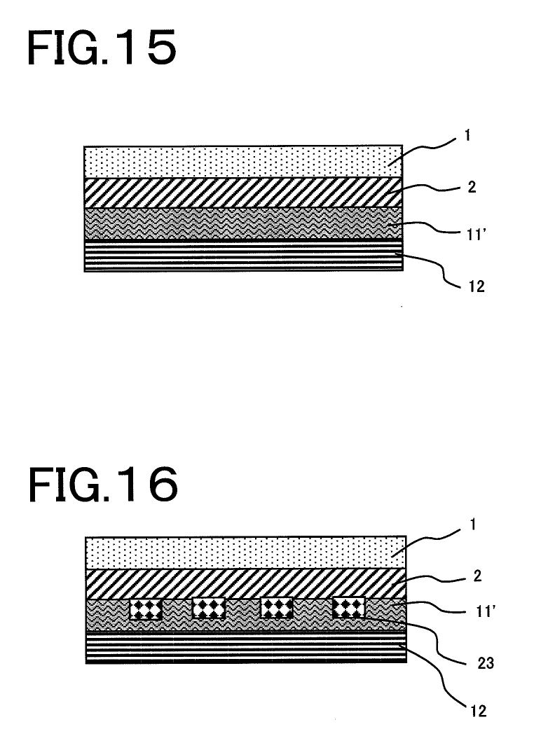

FIGS. 15 and 16 are diagrams illustrating a forgery prevention medium according to an eighth embodiment of the present invention. FIG. 15 is a cross-sectional view of the forgery prevention medium of the eighth embodiment before being given digital watermarking information. FIG. 16 is a cross-sectional view of the forgery prevention medium of the eighth embodiment after being given digital watermarking information.

According to the eighth embodiment, as shown in FIG. 15, an adhesive layer 11′ including a pigment, a dye, metal particles or the like is used for a hologram that has a similar layer configuration to that of the first embodiment illustrated in FIG. 3. After that, as shown in FIG. 16, laser marking is carried out to cause the adhesive layer 11′ to change in quality, thereby recording digital watermarking information. In this case, digital watermarking information is recorded on the adhesive layer 11′ without affecting the hologram layer. Incidentally, digital watermarking information may be recorded on the adhesive layer 11′ before the adhesive layer 11′ and the hologram layer 2 are bonded together.

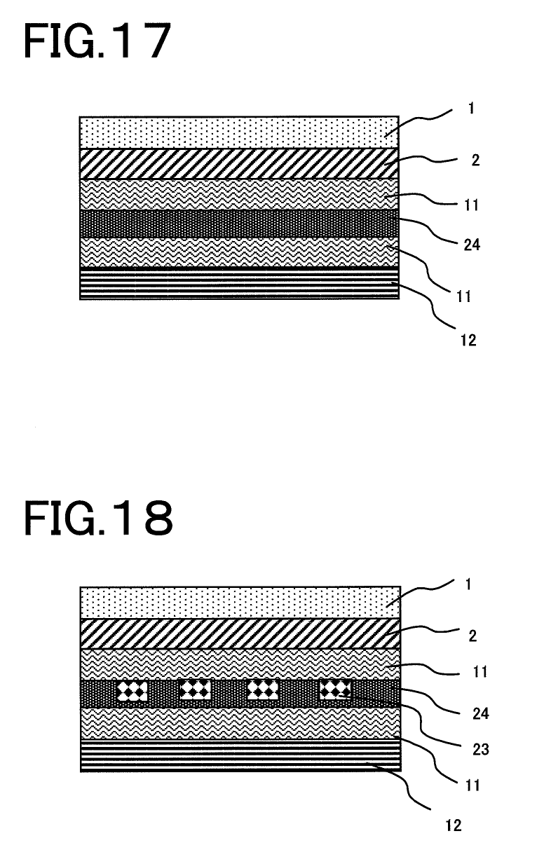

FIGS. 17 and 18 are diagrams illustrating a forgery prevention medium according to a ninth embodiment of the present invention. FIG. 17 is a cross-sectional view of the forgery prevention medium of the ninth embodiment before being given digital watermarking information. FIG. 18 is a cross-sectional view of the forgery prevention medium of the ninth embodiment after being given digital watermarking information.

According to the ninth embodiment, as shown in FIG. 17, inside the adhesive layer 11 having the layer configuration of the first embodiment as illustrated in FIG. 3, a colored film 24, such as PET, that includes a pigment, a dye, metal particles or the like is so provided as to be sandwiched between two adhesive layers 11. After that, as shown in FIG. 18, laser marking is carried out to record digital watermarking information on the colored film 24. In this case, digital watermarking information is recorded on the colored film 24 without affecting the hologram layer. Incidentally, digital watermarking information may be recorded on the colored layer 24 before the adhesive layer 11 and the hologram layer 2 are bonded together.

Information can be also recorded on the outermost PET layer or on the PET layer and the hologram layer by changing the wavelength, output power and the like of a laser used for laser marking. However, since marks border on the surface, it is preferable that the marking of the adhesive layer or of the PET layer sandwiched between the adhesive layers be performed for recording so falsification can be prevented and the layer is rarely affected by scratches and stains.

According to the above first to ninth embodiments, the digital watermarking information of the information layer 21 or 23 and the design of the volume hologram layer 2 are at least partially superimposed after being recorded. In this case, when the digital watermarking information is read, the digital watermarking information is difficult to read due to the effect of a hologram image if the forgery prevention medium is illuminated at an illumination angle set to reproduce the hologram image. Accordingly, when the digital watermarking information is read, a light beam that is different in wavelength, direction or angle from the reproduction illumination beam used to reproduce the hologram image is used; the light beam is preferable because no hologram image is reproduced and only the digital watermarking information is read.

A liquid-crystal information layer may be formed by carrying out a wrapping process of the substrate film 1 illustrated in FIG. 3, performing pattern printing of liquid crystal solution (polymerizable nematic liquid crystal, polymerizable cholesteric liquid crystal or the like) with the use of gravure printing or the like, drying, and emitting an ultraviolet ray. In this case, the layer configuration is the one illustrated in FIG. 4. Moreover, the layer configuration shown in FIGS. 11 and 13 can be formed in a similar way.

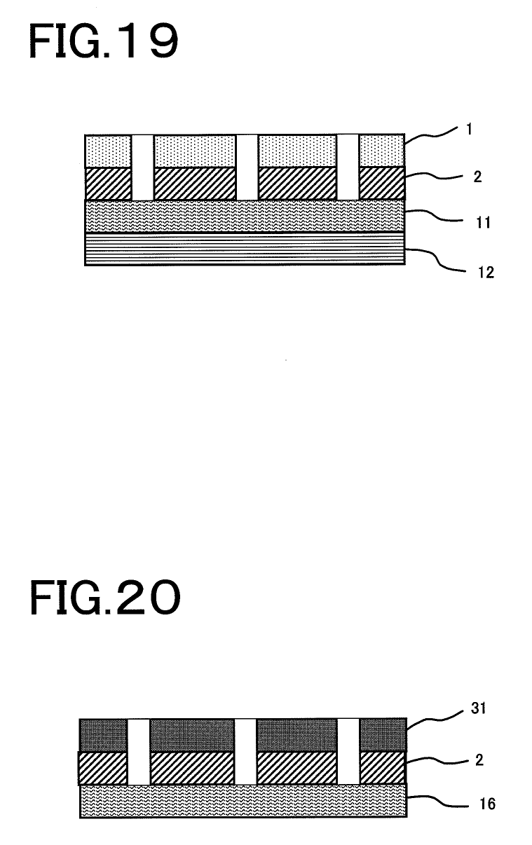

The engraving of the substrate film 1 that is the outermost surface of the hologram label is possible by adjusting the wavelength of a laser for marking. The pattern made by engraving is recorded as information. As shown in FIG. 19, the engraving of the substrate film 1 and the volume hologram layer 2 that have the layer configuration as illustrated in FIG. 3 is possible by adjusting the output power and the frequency. Further adjustment allows the engraving of the adhesive layer below the hologram layer.

Even in the case of the layer configuration illustrated in FIG. 11, the engraving of the surface side can be also done as shown in FIG. 20. However, since the protective layer is detached after transfer, the engraving of the protective layer 31 and the volume hologram layer 2 is possible by adjusting the wavelength of the laser for marking and the pattern made by engraving is recorded as information. Moreover, the engraving of the protective layer 31, the volume hologram layer 2 and the heat seal layer 16 is possible by adjusting the output power and the frequency.

The information layer may be formed by thermal transfer.

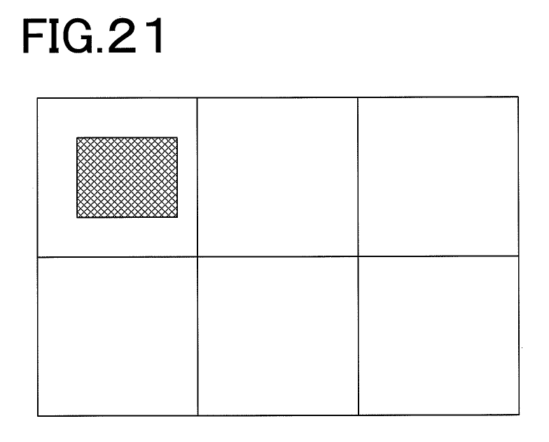

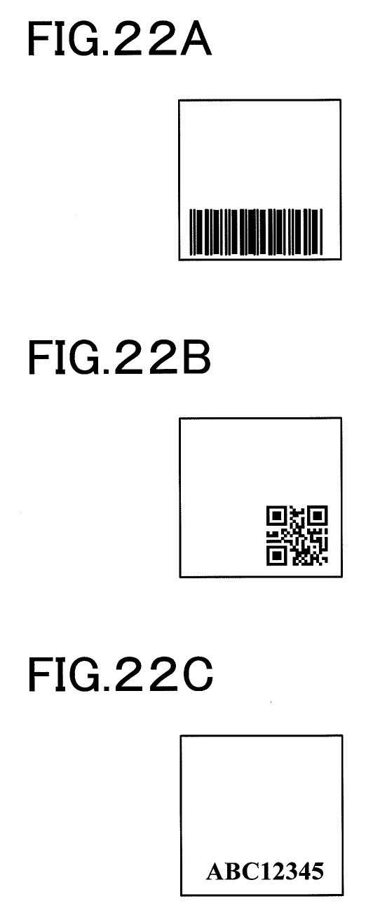

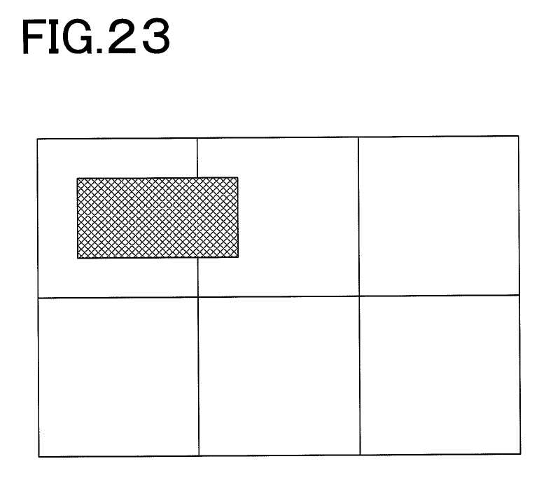

The digital watermarking information may overlap the design of the hologram or may cover the entire design of the hologram. In the case of a multifaceted hologram, if a different kind of information is input into each hologram, it is preferable that the digital watermarking information be stored in an area that is smaller in size than one hologram as shown in FIG. 21 in order to prevent the too much digital watermarking information from spilling over to an adjacent hologram due to misalignment as shown in FIG. 23.

According to the embodiments, the digital watermarking information having a high level of secrecy is used for the hologram having a high level of reliability in terms of security. Therefore, the information is difficult to interpret by eye under normal conditions. Thus, it is possible to improve the effect of forgery prevention. Moreover, since the digital watermarking information having redundancies is used, it is possible to efficiently produce the forgery prevention medium without complicated processes such as alignment.

The above has described the hologram and hologram production method of the present invention on the bases of the embodiments. However, the present invention is not limited to the embodiments; various modifications may be made.

What is claimed is:

1. A forgery prevention medium comprising:
a volume hologram layer on which an interference pattern is recorded after being exposed to at least an emitted laser beam;
a digital watermarking information layer on which digital watermarking information is recorded; and
a substrate film,
the information recorded on the digital watermarking information layer being interpreted by emitting a light beam that is different in one or more of the characteristics, incidence direction, incidence angle and incidence wavelength, from a hologram reproduction illumination beam used to reproduce an image recorded on the volume hologram layer.

2. The forgery prevention medium according to claim 1, wherein
the digital watermarking information layer consists of a resin layer including a pigment or a dye.

3. The forgery prevention medium according to claim 1, wherein
the digital watermarking information layer is made of liquid crystal.

4. The forgery prevention medium according to claim 1, wherein
the digital watermarking information layer is formed after being changed in quality or engraved.

5. The forgery prevention medium according to claim 1, wherein
the digital watermarking information layer is formed by printing.

6. The forgery prevention medium according to claim 1, wherein
the digital watermarking information layer is formed by thermal transfer.

7. The forgery prevention medium according to claim 1, wherein
the digital watermarking information layer is formed by a laser.

8. The forgery prevention medium according to claim 1, wherein
the digital watermarking information layer is formed on the surface of the forgery prevention medium.

9. The forgery prevention medium according to claim 8, wherein
a protective layer that protects the digital watermarking information layer is formed on the surface of the forgery prevention medium on which the digital watermarking information layer is formed.

10. The forgery prevention medium according to claim 1, wherein
the digital watermarking information layer is formed inside the forgery prevention medium.

11. The forgery prevention medium according to claim 1, wherein
an adhesive layer that is to be detached from the substrate film and bonded to an adherend is provided.

12. The forgery prevention medium according to claim 1, wherein
a heat seal layer is provided to thermally transfer the volume hologram layer to an adherend.
